(19) United States
(12) Patent Application Publication
(10) Pub. No.: US 2013/0252218 A1
(43) Pub. Date: Sep. 26, 2013

(54) CPR and First Aid Training System and Method

(71) Applicants: Merrilee C. Sweet, Dallas, TX (US); Jerald F. Potts, Gent (BE)

(72) Inventors: Merrilee C. Sweet, Dallas, TX (US); Jerald F. Potts, Gent (BE)

(21) Appl. No.: 13/430,035

(22) Filed: Mar. 26, 2012

(51) Int. Cl. G09B 23/28

(52) U.S. Cl. CPC G09B 23/288
USPC 434/265

(57) ABSTRACT

This invention relates to a CPR and first aid training system and method that is designed to teach people the cognitive knowledge and psychomotor skills related to first aid and CPR using self-directed educational strategies that include real-time feedback about the quality of the person's performance. The training system integrates software and hardware components as well as the use of either a manikin or non-human like surrogate for compression practice.

### BACKGROUND OF THE INVENTION

1. Field of the Invention

This invention relates to a CPR and first aid training system and method that by integrating software and hardware components is designed to teach people the cognitive knowledge and psychomotor skills related to first aid and CPR using self-directed educational strategies that include real-time feedback about the quality of the person's performance.

2. Description of Related Art

Sudden cardiac arrest is a leading cause of death as nearly 300,000 people in the United States annually suffer cardiac arrest in public and private locations. On average, only 8% survive. CPR can more than double or triple the victim's chance of survival, but only 31% of out-of-hospital victims receive CPR from a bystander. Training lay audiences in CPR has historically had many barriers including time, access to training, financial barriers and motivation to learn.

Recently the ECC guidelines for CPR and emergency cardiovascular care were updated to recommend the technique of compression-only CPR, rather than the traditional compression and mouth-to-mouth resuscitation. The American Heart Association created the terminology “Hands-Only” to describe this technique and further research has demonstrated the value of brief training videos in this new recommended CPR technique. Although training videos are useful, they do not provide the viewer the chance to practice the technique or provide any feedback about the person's performance.

It is therefore desirable to have a CPR and first aid training system that increases the number of people trained to provide assistance in a cardiovascular emergency, while overcoming the traditional training barriers. Furthermore, it is desirable to have a training system that, while brief, is still hands-on and provides real-time feedback of the person's performance.

### SUMMARY OF THE INVENTION

The present invention provides a CPR and first aid training system (e.g., in the form of a kiosk) that teaches people the cognitive knowledge and psychomotor skills related to first aid and CPR using self-directed educational strategies that include real-time feedback about the quality of the person's performance. This is accomplished through a system (e.g., training kiosk) that integrates software and hardware components as well as the use of either a manikin or non-human like surrogate for compression practice. The training provided by the system would require only a minimal time commitment and be easily accessible by the general public, thereby eliminating or significantly reducing many of the traditional barriers to CPR training. The system is an efficient way to increase the number of people who are prepared to aid victims in an emergency generally and specifically victims of a cardiovascular emergency whose chance of survival is more than doubled when a bystander immediately provides CPR.

Preferably, this training system is placed in high traffic areas where the audience is idle or has limited opportunities for other activities, such as an airport. Air travelers often have ample time while waiting for flights and are often seeking activities to fill the time. Furthermore, certain studies have found that airports have the highest incidences of cardiac arrests of all public locations. While it is believed airports are an ideal location for the training kiosk, other high traffic locations (e.g., shopping malls) or idle audience locations (e.g., hospital waiting rooms) would also be suitable locations. These locations would offer the opportunity to increase awareness of Hands-Only CPR, as well as increase the number of people trained and therefore likely to perform CPR or first aid in a cardiovascular emergency. Additionally, incentives such as airline miles or gift cards could be offered to entice more participants to complete the training provided by the system.

In a preferred embodiment, the system has the following main components: an interactive screen, training software and a psychomotor skills training manikin or non-human surrogate for compression practice. The training software provides the training materials (e.g., instructions, instructional videos, etc.) and is connected to the training manikin to provide real-time performance evaluation and feedback to the person receiving the training. The training system provides the user the opportunity to select various training topics (CPR, first aid, etc.) or informational topics (cardiovascular risks, preventative tips, etc.). Once the user selects a training activity, the instructions for the activity will be displayed on the screen. The user will then perform the activity and receive his or her score and be offered the chance to perform the activity again.

The novel features and construction of the present invention, as well as additional objects thereof, will be understood more fully from the following description when read in connection with the accompanying drawings.

### BRIEF DESCRIPTION OF THE DRAWINGS

The improved system and method of the invention is further described and explained in relation to the following system and method drawings wherein:

FIG. 1 is a depiction of the training system of the present invention.

FIG. 2 is flow chart showing the training method for the system.

FIG. 3 is a flow chart showing the training software logic for the system.

FIG. 4 is a flow chart showing the training software logic for the system.

### DESCRIPTION OF THE PREFERRED EMBODIMENTS

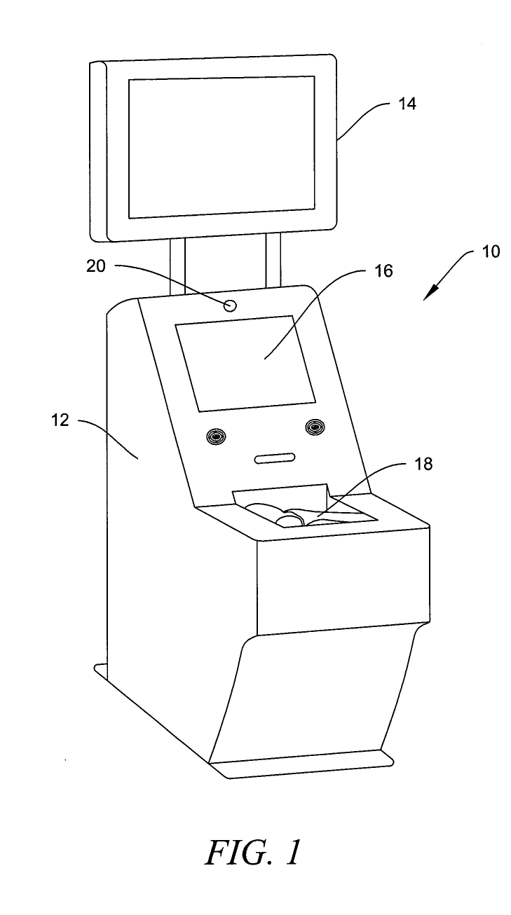

Referring to FIG. 1, a depiction of the preferred embodiment of the training system is shown. The training system is preferably in the form of stand-alone kiosk 10 or training station located in a heavily-trafficked area. Stand-alone kiosk 10 comprises computer (12, residing in body of kiosk), display screen 14, user input device 16, CPR psychomotor skills training device 18 and webcam 20. Furthermore, training software resides on computer 12 that is coupled to display screen 14. In a preferred embodiment, user input device 16 is a touch screen monitor that allows user inputs to be made directly on the screen. Alternatively, a separate keyboard or keypad could also be used for user input. In a preferred embodiment, CPR psychomotor skills training device 18 is a half-body manikin for the user to practice CPR chest compressions. Device 18 is electronically connected to computer 12, so that the training software can monitor the number, frequency and depth of the practice compressions. Alternatively, device 18 could be a non-human-shaped surrogate that also allows practice chest compressions. Additionally, the training system could also include a printer for printing certificates of completion for users that successfully complete the training activity(ies). In a preferred embodiment, computer 12 would be connected to the internet to provide the operators of the training system information about the number of users, the topics selected and the demographic characteristics of the users, such that further refinements to the system could be made.

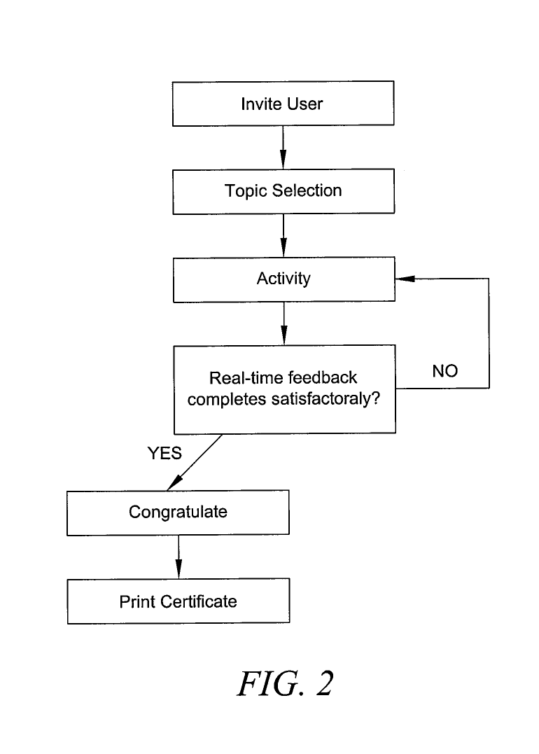

Referring to FIG. 2, a flow chart showing a preferred embodiment of the CPR and first aid training method is shown. The first step is inviting the user to participate in the training, which is accomplished through the use of display screen 14 along with advertising or other graphics located on kiosk 10. Additionally, if an incentive is being offered to encourage participation, this is displayed on the screen as well as the exterior of the kiosk. Once the user decides to participate, a welcome screen is displayed on screen 14. Preferably, this welcome screen gives the user the chance to enter his or her name, sex, age and any other pertinent demographic information. Also, if an incentive is being offered, the user is asked at the welcome screen to also enter any necessary information to award the incentive to the user (e.g., the airline account number for the airline miles).

The second step of the training method is to have the user select a training topic. This is accomplished by providing the user a menu of topics from which to choose such as CPR/AED, first aid, cardiovascular risk, etc. Preferably, this menu would appear on display screen 14. The topics offered could include any number of health or first aid related topics, including but not limited to, CPR/AED, first aid and cardiovascular risks. In the preferred embodiment, the topics would be mainly focused on the CPR aspect of the training to ensure that the majority of the participants complete the CPR training as that is the primary goal. However, this main thrust of training could be selected based on the immediate needs of the community or region where the training kiosk is located if there was some region specific training desired. After the user selects a topic from the menu, a topic-specific sub-menu appears on the display screen, which provides the user the opportunity to select the specific training activity in which he or she wishes to participate. The third step of the training method is for the user to perform the selected training activity. As way of an example, if the user selects CPR training, then the user would perform chest compressions on psychomotor training skills device 18. After the training activity is completed, the final step of the training method is to provide the user real-time feedback on how well the activity was performed. With the CPR example, the user would receive a score and be notified of how effective the practiced chest compressions would have been in a emergency situation. If the user performed satisfactorily, display screen 14 would display a congratulations screen and a certificate of completion could be printed if desired. If performed unsatisfactorily, then the user would be given feedback of what to improve on and given the opportunity to perform the activity again.

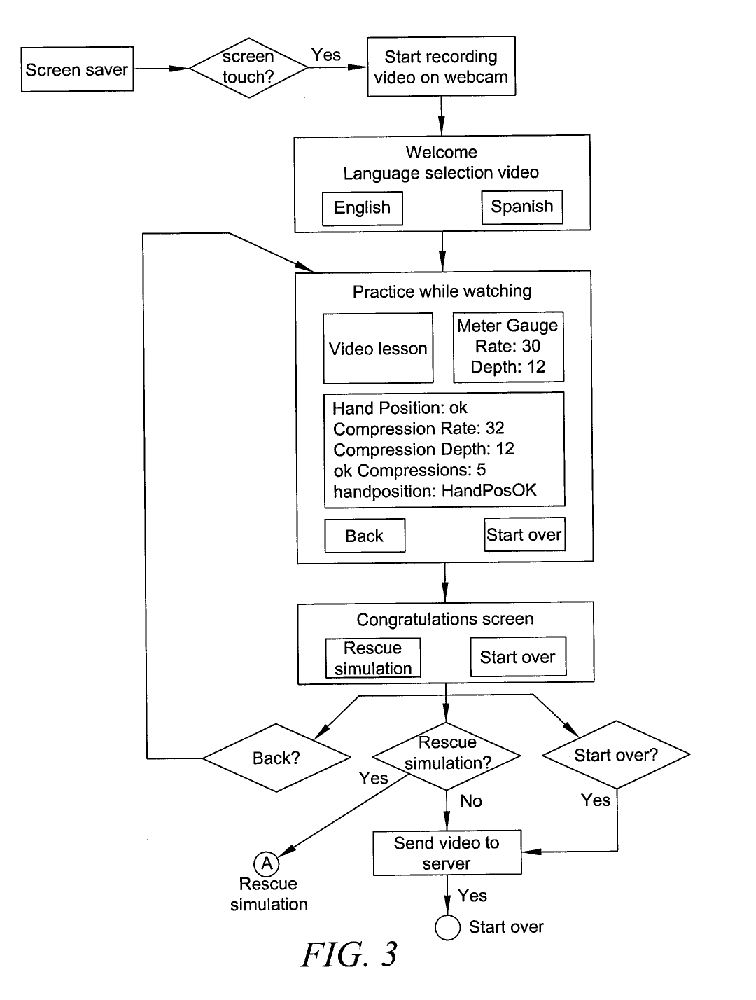

Referring to FIG. 3, a flow chart showing the software logic of the CPR and first aid training system is shown. When the kiosk is not in use, the software is idle and the screen displays an invitation to participate and become trained. Once a user inputs his or her desire to participate (e.g., through the use of a start button on the screen), the software becomes active and displays a welcome screen. Additionally, attached webcam 20 starts recording the training session. The user is prompted to select his or her preferred language. There is a time-out period wherein the software will return to its idle state if the user does not provide the input or use the touch screen within an allotted time frame. This is to ensure that the system is reset for a new user if a previous user decides to leave the training kiosk before the training is complete.

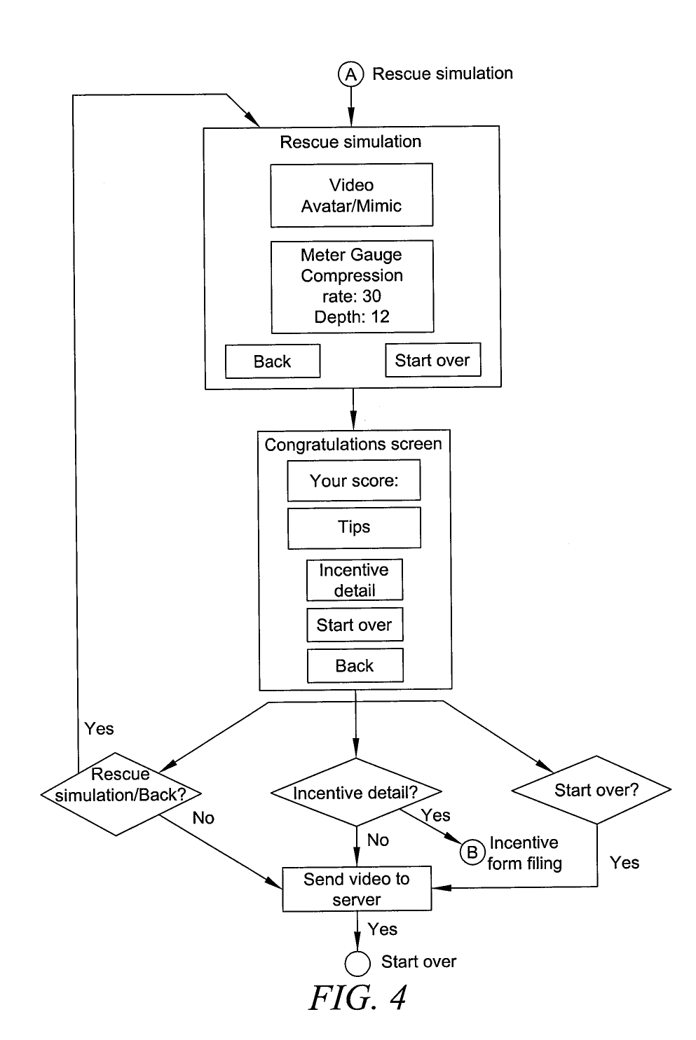

The software next allows the user to practice the activity while watching a video on display 14. In the preferred embodiment, the training video teaches the correct placement of the hands, the correct compression rate, and the correct compression depth. The user will then perform the chest compressions on the manikin or non-human surrogate to develop the necessary psychomotor skills to perform the technique in an emergency. The training software manikin is capable of recording the number, frequency and depth of the practice compressions and providing an analysis of how effective the compressions would have been in a real life emergency. The user practices the taught method and receives feedback on if they are performing the activity satisfactorily. At the conclusion of the training video, the user can start the training video again by pressing the back button, start the entire activity over, or move on to the actual simulation (FIG. 4). If the user chooses to start over or not go forward to the simulation, then the video is sent to the server and the software returns to the original welcome screen.

Referring to FIG. 4, a flow chart showing the software logic actual simulation portion of the training is shown. In the preferred embodiment, the simulation begins by showing a short video, and the user is then required to perform the life-saving activity on manikin 18. The system determines whether the hands are in the proper position and measures the compression rate and compression depth. After the simulation is complete, the user is given a score and the opportunity to perform the simulation again or return to the start screen. If the user chooses neither, a congratulations screen is shown, which provides the user his or her score on simulation and tips to perform better. If incentives to participate are going to be provided (such as airline miles, flight drink coupons or gift cards), then a software loop to allow the user to enter his choice of incentive and/or other necessary information required to provide the incentive (e.g., personal airline miles ID number) is activated. At this point, the user is given the choice to go back and perform the simulation again, or start over. Once the user selects start over, then the video is sent to the server.

Other alterations and modifications of the invention will likewise become apparent to those of ordinary skill in the art upon reading the present disclosure, and it is intended that the scope of the invention disclosed herein be limited only by the broadest interpretation of the appended claims to which the inventors are legally entitled.

1. A system for first aid training comprising:
a kiosk;
a computer with training software;
a display device for providing instructions;
an input device to allow a user to input information and make selections; and
a training device for the user to practice the first aid training;
wherein the training software is connected to the training device to provide real-time performance evaluation and feedback to the user receiving the training.

2. The system of claim 1 wherein the kiosk houses the computer, display device, input device and training device.

3. The system of claim 1 wherein the display device is capable of displaying videos.

4. The system of claim 1 wherein the display device also serves as the input device.

5. The system of claim 1 wherein the input device is a touch screen monitor.

6. The system of claim 1 wherein the input device is a keyboard.

7. The system of claim 1 wherein the training device is a psychomotor skills training device in the shape of a half-body manikin.

8. The system of claim 1 wherein the training device is a non-human shaped surrogate.

9. The system of claim 1 further comprising a printer.

10. The system of claim 1 wherein the first aid training comprises CPR training.

11. A method for first aid training comprising:
providing a computer with training software;
providing a display device for providing instructions;
providing an input device; and
providing a training device;
wherein the display device provides instructions and techniques for a user who practices the first aid instructions and techniques on the training device, which is connected to the computer that provides real-time performance evaluation and feedback.

12. The method of claim 11 wherein the first aid training is CPR training.

13. The method of claim 11 wherein the first aid training occurs through the use of a stand-alone kiosk that houses the computer, display device, input device and training device.
